(19) United States
(12) Patent Application Publication
(10) Pub. No.: US 2016/0329823 A1
(43) Pub. Date: Nov. 10, 2016

(54) POWER CONVERSION DEVICE

(71) Applicant: AISIN AW CO., LTD., Anjo-shi, Aichi-ken (JP)

(72) Inventors: Yasushi NAKAMURA, Nishio (JP); Yuji TAKAKURA, Anjo (JP)

(73) Assignee: AISIN AW CO., LTD., Anjo-shi, Aichi-ken (JP)

(21) Appl. No.: 15/108,929

(22) PCT Filed: Jan. 19, 2015
(86) PCT No.: PCT/JP2015/051204

§ 371 Date: Jun. 29, 2016

(30) Foreign Application Priority Data
Jan. 28, 2014 (JP) 2014-013512

(51) Int. Cl. H02M 3/335; H02M 1/08

(52) U.S. Cl. CPC H02M 3/33546; H02M 1/08

(57) ABSTRACT

A power conversion device including at least two transformers having a first transformer and a second transformer, each for transforming a power between a primary coil and a secondary coil, wherein each secondary coil of the first transformer and the second transformer includes a positive output coil whose output voltage is positive, and a negative output coil whose output voltage is negative with respect to a reference voltage on a secondary side, and output powers of the positive output coil and the negative output coil are different from each other.

### BACKGROUND

The present disclosure relates to a power conversion device having a transformer that transforms a power between a primary coil and a secondary coil.

For example, an AC motor of a large output used for a power of electric vehicles, hybrid electric vehicles and the like is driven by a high voltage. Since a power supply of the high voltage mounted on such vehicles is a DC battery, the voltage is converted into a three-phase alternating current by an inverter circuit using a switching element. A signal for driving the inverter circuit, for example, a control signal of the switching element is generated by a control circuit that is insulated from a high voltage circuit that supplies a drive power to the motor, and operates at a voltage much lower than that of the high voltage circuit. Therefore, for example, as illustrated in FIG. 1 of JP-A-2009-130967, the control device for driving the motor is equipped with a drive circuit for relaying a control signal generated by the control circuit to the inverter circuit. As illustrated in FIG. 3 of JP-A-2009-130967, a transformer is frequently used for the power supply of the drive circuit in order to secure insulation between the inverter circuit and the control circuit.

Incidentally, a negative power supply may be required for the drive circuit in order to obtain a desired output. In this case, a positive output coil that outputs a positive voltage to a reference voltage (for example, ground) and a negative output coil that outputs a negative voltage are required, and a difference may occur in output power between the positive output coil and the negative output coil. When the power difference is as relatively large as twice or greater, a power consumption (current consumption) is unbalanced in a power source circuit on a primary side of the transformer. For example, the power consumption of switching elements (M1, M2) configuring the power source circuit on the primary side is unbalanced in FIG. 3 of JP-A-2009-130967. It is preferable that each of circuit elements (for example, switching elements) configuring a primary side circuit is formed of components having the same specification of electric characteristics. However, when the components are selected to fit a side on which the power consumption is larger, the components on a side where the power consumption is relatively smaller are overengineered.

For that reason, a component cost and a substrate cost caused by an area increase of a mounting substrate are likely to increase.

### SUMMARY

In view of the above background, it is desirable to provide a transformer type power conversion device configured to include a secondary coil having a positive output coil whose output voltage is positive with respect to a reference voltage of a secondary side and a negative output coil whose output voltage is negative, and to balance a power consumption of a circuit connected to a primary coil even when output powers of the positive output coil and the negative output coil are different from each other.

In view of the above problem, a power conversion device according to the disclosure includes at least two transformers having a first transformer and a second transformer, each for transforming a power between a primary coil and a secondary coil, in which each secondary coil of the first transformer and the second transformer includes a positive output coil whose output voltage is positive, and a negative output coil whose output voltage is negative with respect to a reference voltage on a secondary side, and output powers of the positive output coil and the negative output coil are different from each other, each destination of a first power wiring and a second power wiring which are two wirings for connecting an AC power source to the primary coils is any one of two connection ends of the primary coil, and different from each other between the first transformer and the second transformer, or polarities of the positive output coil and the negative output coil are different from each other between the first transformer and the second transformer.

When each destination of the first power wiring and the second power wiring is any one of two connection ends of the primary coil, and different from each other between the first transformer and the second transformer, even if the first transformer and the second transformer are configured by the same hardware, actions on the secondary coils can be made different from each other. When the polarities of the positive output coil and the negative output coil are different from each other between the first transformer and the second transformer, even if connection configurations of the power wirings to the first transformer and the second transformer are identical with each other, the actions on the secondary coils can be made different from each other. For example, a current flowing in the first power wiring acts on the negative output coil of the second transformer when acting on the positive output coil of the first transformer, and acts on the positive output coil of the second transformer when acting on the negative output coil of the first transformer. On the other hand, a current flowing in the second power wiring acts on the positive output coil of the second transformer when acting on the negative output coil of the first transformer, and acts on the negative output coil of the second transformer when acting on the positive output coil of the first transformer. In other words, since the currents flowing in the first power wiring and the second power wiring evenly act on the positive and negative outputs of the first transformer and the second transformer, respectively, the current flows in the first power wiring and the second power wiring in a balanced manner. Therefore, the transformer type power conversion device configured to balance the power consumption of the circuits connected to the respective primary coils can be realized even when the positive output coil and the negative output coil are different in output power from each other.

Further features and advantages of the disclosure will become clear from the following description of embodiments of the disclosure with reference to the drawings.

### BRIEF DESCRIPTION OF THE DRAWINGS

FIG. 1 is a block diagram schematically illustrating a configuration example of a motor control device.

FIG. 2 is a block diagram schematically illustrating a first configuration example of a power conversion device.

FIG. 3 is a block diagram schematically illustrating a conventional configuration example corresponding to the first configuration example.

FIG. 4 is a diagram illustrating a current waveform on a primary side in the first configuration example.

FIG. 5 is a diagram illustrating a current waveform on a primary side in a conventional configuration example corresponding to the first configuration example.

FIG. 6 is a block diagram schematically illustrating a second configuration example of the power conversion device.

FIG. 7 is a block diagram schematically illustrating a conventional configuration example corresponding to the second configuration example.

FIG. 8 is a diagram illustrating a current waveform on a primary side in the second configuration example.

FIG. 9 is a diagram illustrating a current waveform on a primary side in a conventional configuration example corresponding to the second configuration example.

FIG. 10 is a block diagram schematically illustrating a third configuration example of the power conversion device.

### DETAILED DESCRIPTION OF EMBODIMENTS

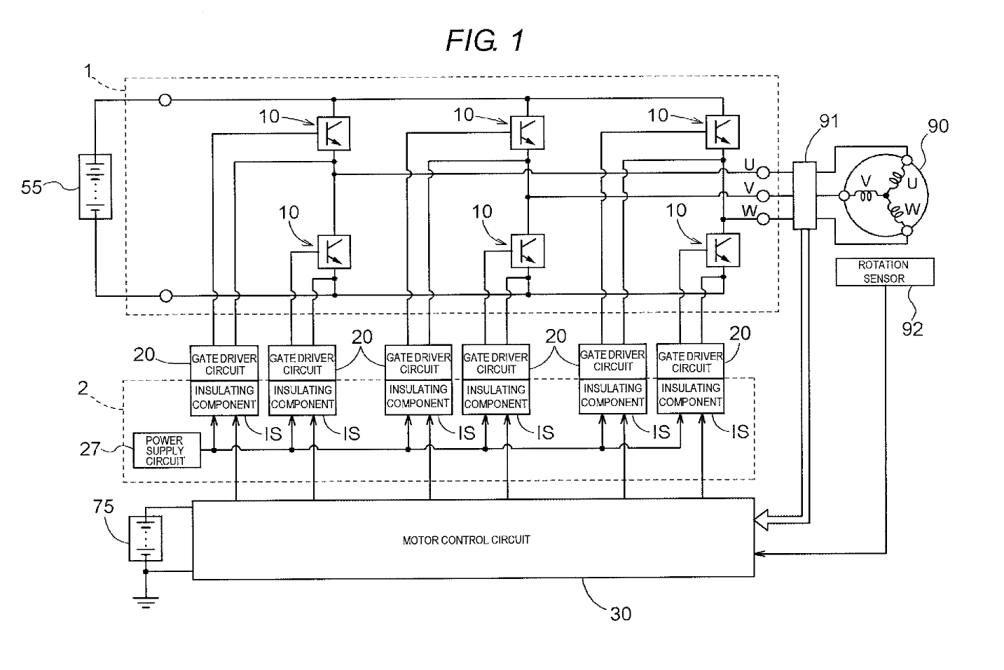

Hereinafter, a power conversion device for use in a motor control device for controlling a power motor (rotating electrical machine) of electric vehicles or hybrid vehicles will be described according to embodiments of the disclosure. First, a configuration of the motor control device will be described with reference to FIG. 1. A motor 90 is a three-phase AC motor and functions as a power generator.

The motor control device includes an inverter circuit 1 that converts a direct current into a three-phase alternating current with the use of switching elements such as IGBTs (insulated gate bipolar transistors) or FETs (field effect transistors). Naturally, the inverter circuit can be configured by using power transistors of various structures such as a bipolar type. As illustrated in FIG. 1, the inverter circuit 1 includes six switching elements 10. Each of the switching elements 10 includes a free wheel diode.

A DC voltage is applied to the switching elements 10 from a high voltage battery 55 serving as a high voltage power supply, and converted into three-phase alternating currents of a U-phase, a V-phase, and a W-phase. When the motor 90 is a vehicle power motor, a DC voltage of several hundred volts is input to the switching elements 10, and three-phase motor drive currents are output from the respective switching elements 10. Those motor drive currents are connected to stator coils of the U-phase, the V-phase, and the W-phase of the motor 90.

The motor control device includes a motor control circuit 30 that operates at a much lower voltage than a supply voltage of the inverter circuit 1. A direct current voltage of, for example, about 12 volts is applied to the motor control circuit 30 from a low voltage battery 75 serving as a low voltage power supply. Meanwhile, the low voltage power supply is not limited to the low voltage battery 75, but may be configured by a DC-DC converter that steps down a voltage across the high voltage battery 55. The motor control circuit 30 includes a microcomputer and a DSP (digital signal processor) as core components. Since operating voltages of the microcomputer and the DSP are generally 3.3 volts or 5 volts, the motor control circuit 30 also includes a regulator circuit that generates the operating voltages from the supply voltage of 12 volts which is applied from the low voltage battery 75.

The motor control circuit 30 controls the motor 90 according to a command acquired from an ECU (electronic control unit) not shown for controlling the operation of the vehicle through a communication such as a CAN (controller area network).

The motor control circuit 30 receives detection signals from a current sensor 91 and a rotation sensor 92 which detect the behavior of the motor 90, and executes a feedback control according to an operating state of the motor 90. The motor control circuit 30 generates a drive signal for driving the switching elements 10 of the inverter circuit for the purpose of controlling the motor 90. When the switching elements 10 are IGBTs or FETs, since control terminals of those switching elements 10 are gate terminals, the drive signals input to the control terminals are called “gate drive signals” in the present embodiment.

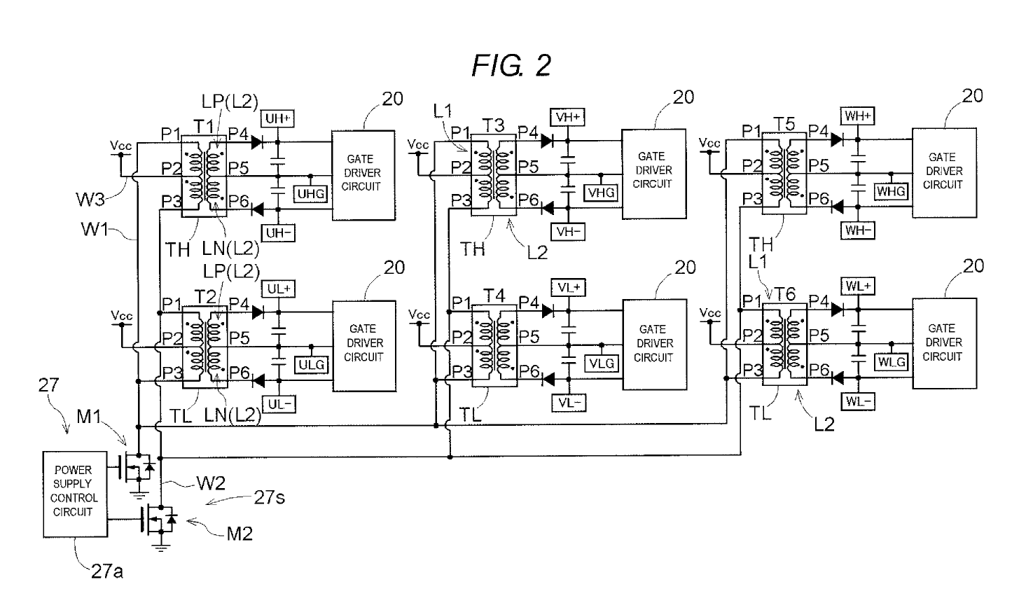

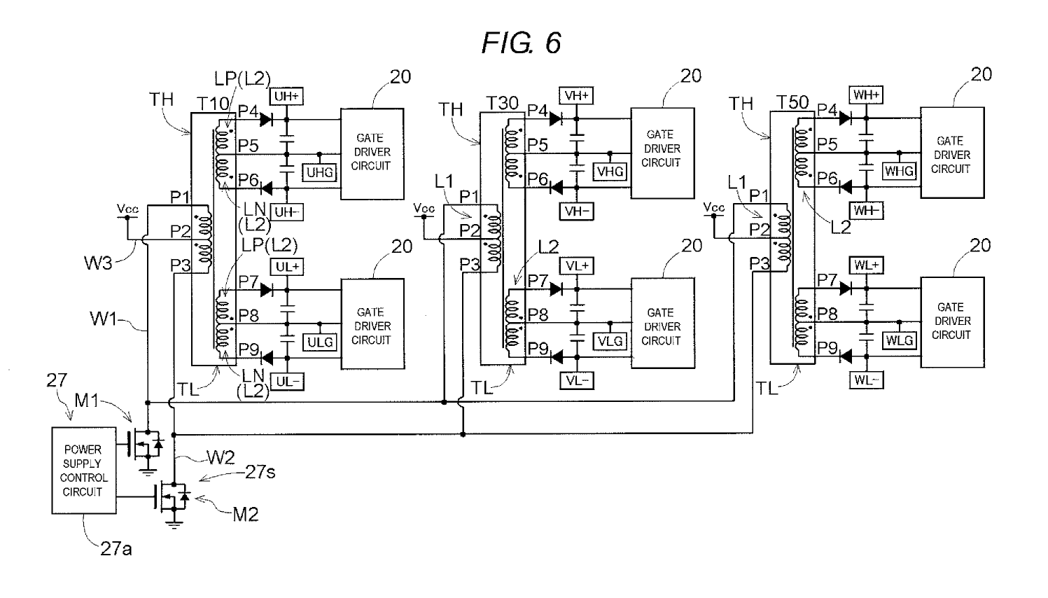

The motor control device includes gate driver circuits 20 that drive the respective switching elements 10 in the inverter circuit 1 on the basis of the gate drive signals generated in the motor control circuit 30. The motor control device also includes a power supply circuit 2 (power conversion) that supplies a power to the gate driver circuits 20. The power supply circuit 2 includes transformers (T1 to T6, T10 to T50) serving as insulating components IS (refer to FIGS. 2, 6, and so on). Each of the transformers is a known insulating component for electromagnetically coupling a primary coil with a secondary coil to transmit a signal and an energy. Therefore, each transformer can supply the supply voltage to the gate driver circuits 20 and so on while keeping insulation between a low voltage circuit and a high voltage circuit. Meanwhile, the power supply circuit 2 is controlled by a power source circuit 27. Each of the insulating components IS includes a photocoupler (not shown) for transmitting the gate drive signal generated by the motor control circuit 30 to the corresponding gate driver circuit 20. Each photocoupler is a known insulating component having a light emitting diode on an input side, and a photodiode or a phototransistor on an output side, and which transmits a light from the input side to the output side wirelessly. Therefore, the photocoupler can transmit the gate drive signal to the corresponding gate driver circuit 20 while keeping the insulation between the low voltage circuit and the high voltage circuit.

As described above, the inverter circuit 1 is the high voltage circuit that operates at the high voltage, and the motor control circuit 30 is the low voltage circuit that operates at the low voltage. The high voltage circuit and the low voltage circuit are spaced apart from each other by a predetermined insulation distance. The high voltage circuit and the low voltage circuit are coupled with each other by the insulating components IS described above wirelessly. For example, the gate drive signals generated in the motor control circuit 30 belonging to the low voltage circuit are connected to input terminals of the respective photocouplers that are the insulating components IS. Output terminals of the photocouplers are connected to driver ICs of the respective gate driver circuits 20 belonging to the high voltage circuit. The gate drive signals are transmitted to the respective gate driver circuits 20 from the motor control circuit 30 by the photocouplers in a state where the insulation between the low voltage circuit and the high voltage circuit is kept. The driving of the switching elements 10 in the inverter circuit 1 belonging to the high voltage circuit is controlled by the driver ICs of the gate driver circuits 20.

As described above, the motor control device includes the power supply circuit 2 for supplying the power to the gate driver circuits 20. As illustrated in FIG. 2 and so on, the power supply circuit 2 includes the transformers (T1 to T6) serving as the insulating components IS. A primary voltage (Vcc) to the transformers (T1 to T6) is stabilized at a constant voltage and supplied in a constant voltage circuit of the motor control circuit 30 that is the low voltage circuit. As described above, for example, the supply voltage of 12 volts is supplied to the motor control circuit 30 from the low voltage battery 75, but the voltage across the battery is varied depending on a load. Hence, the primary voltage (Vcc) of the constant voltage stabilized by the constant voltage circuit configured by a regulator IC is supplied to the transformers (T1 to T6).

In the present embodiment, the six transformers (T1 to T6) are provided in correspondence with the respective six switching elements 10 of the inverter circuit.

Secondary voltages are output from the respective transformers (T1 to T6). The respective transformers (T1 to T6) have the same configuration, and substantially the same secondary voltages are output from the respective transformers (T1 to T6). In FIG. 2, diodes disposed on the secondary side of the respective transformers (T1 to T6) are rectifying diodes, and capacitors are smoothing capacitors, and a rectifier circuit is configured by those components.

The power source circuit 27 (AC power source) controls the transformers (T1 to T6) serving as the power supply circuit 2. The power source circuit 27 includes a switching control circuit 27s having two switching elements (M1, M2) for controlling a voltage to be applied to a primary coil L1, and a power supply control circuit 27a that controls those switching elements (M1, M2). In this example, a push-pull type configuration is illustrated as the power source circuit 27. An AC is output from the power source circuit 27, and the power source circuit 27 operates as the AC power source. As described above, since the primary voltage (Vcc) to the transformers (T1 to T6) is stabilized, an output voltage on the secondary side is determined according to a transformer ratio of the transformers (T1 to T6) without feeding the output voltage on the secondary side back to the primary side.

As described above, the power supply circuit 2 supplies the power to the gate driver circuits 20 for driving the respective switching elements 10 in the inverter circuit 1. In this case, when the switching elements 10 are the IGBTs, a threshold voltage at which on/off operation is switched over is roughly about 6 to 7 [V]. In that case, even if the secondary voltage is varied by noise or the like, the secondary voltage provides a sufficient margin for the reference voltage (for example, ground on the secondary side: **G (UHG, VHG, WHG, ULG, VLG, WLG)) of the secondary voltage, and a noise immunity is likely to be ensured. On the other hand, when the switching elements 10 are MOSFETs made of silicon carbide (SiC), the threshold voltage is lower than that of IGBT, and may be roughly about 2.5 [V]. Therefore, as compared with a case in which the switching elements 10 are the IGBTs, the noise immunity becomes lower. Meanwhile, “U, V, W” of the reference voltage “**G” indicate reference voltages of the power supply which are supplied to the gate driver circuits 20 of the switching elements 10 corresponding to the U-phase, the V-phase, and the W-phase of the inverter circuit 1, respectively. “H, L” of the reference voltage “**G” indicate reference voltages of the power supply which are supplied to the gate driver circuits 20 of the switching elements 10 corresponding to an upper (H) side and a lower (L) side of each phase of the inverter circuit 1, respectively.

An SiC-MSFET is higher in switching speed than the IGBT, and also higher in heat resistance. For that reason, if the productivity and costs can be satisfied, an adoption rate is likely to significantly grow in the future. On the other hand, the SiC-MSFET suffers from a problem with the noise immunity as described above. For that reason, for example, in order to sufficiently ensure the amplitude of the gate drive signals, it is preferable that a negative voltage lower than the reference voltage (**G) of the secondary voltage is given to improve a saturation characteristic of the gate driver circuits 20, and ensure a voltage difference between the positive voltage and the reference voltage (**G).

In FIG. 2, secondary voltages “**+(UH+, VH+, WH+, UL+, VL+, WL+)” indicate positive voltages with respect to the reference voltage (**G), and are, for example, “+15 to +20 [V]”. Likewise, in FIG. 2, secondary voltages “**−(UH−, VH−, WH−, UL−, VL−, WL−)” indicate negative voltages with respect to the reference voltage (**G), and are, for example, “−5 to −10 [V]”. The “U, V, W” of the positive voltage “**+” and the negative voltage “**−” indicate voltages of the power supply which are supplied to the gate driver circuits 20 of the switching elements 10 corresponding to the U-phase, the V-phase, and the W-phase of the inverter circuit 1, respectively. The “H, L” of the positive voltage “**+” and the negative voltage “**−” indicate voltages of the power supply which are supplied to the gate driver circuits 20 of the switching elements 10 corresponding to an upper (H) side and a lower (L) side of each phase of the inverter circuit 1, respectively.

As described above, each of the transformers (T1 to T6) includes a positive output coil LP whose output voltage is positive (**+) and a negative output coil LN whose output voltage is negative (**−) with respect to the reference voltage (**G) on the secondary side so that the positive voltage “**+” and the negative voltage “**−” can be output to the secondary side. The positive output coil LP and the negative output coil LN are electrically connected to each other, and a connection point (P5) between the positive output coil LP and the negative output coil LN is set to the reference voltage (**G). In the transformers (T1 to T6), transformers that supply the power to the respective gate driver circuits 20 of the switching elements 10 on an upper (H) side of the respective phases of the inverter circuit 1 are referred to as “upper side transformers TH”, and transformers that supply the power to the respective gate driver circuits 20 of the switching elements 10 on a lower (L) side of the respective phases are referred to as “lower side transformers TL”. In a configuration illustrated in FIG. 2, the upper side transformers TH correspond to the first transformers, and the lower side transformers TL correspond to the second transformers. The power supply circuit 2 (power conversion device) includes at least two transformers each transforming the power between the primary coil L1 and the secondary coil L2, with the inclusion of the first transformer (TH) and the second transformer (TL).

Incidentally, as described above, when the positive and negative voltages are different voltages such that the positive voltage is “+15 to +20 [V], and the negative voltage is “−5 to −10 [V]”, and a ratio of an output current of the positive output coil LP and an output current of the negative output coil LN is smaller than an inverse ratio of a ratio of the voltages, the output powers of the positive output coil LP and the negative output coil LN are different from each other. In this situation, an imbalance is likely to occur in the power consumption of the switching elements (M1, M2) configuring the power source circuit 27 (refer to FIG. 5 and so on, details will be described later). For that reason, as illustrated in FIG. 2, the power supply circuit 2 (power conversion device) is configured in such a manner that each destination of a first power wiring W1 and a second power wiring W2, which are two wirings connecting the power source circuit 27 (AC power source) to each primary coil L1, is any one of two connection ends (P1, P3) of the primary coil L1, and different from each other between the upper side transformer TH (first transformer) and the lower side transformer TL (second transformer).

As illustrated in FIG. 2, in the primary coil L1 (1-2-3 winding), an intermediate point “P2” is connected to a primary voltage (Vcc) through a third power wiring W3, and both ends “P1, P3” are connected to a ground on the primary side through the switching elements (M1, M2) which are supplementally switched through the power supply control circuit 27a, respectively. Specifically, a first terminal “P1” of the upper side transformer TH (first transformer) is connected to the ground on the primary side through the first power wiring W1 and a first switching element M1, and a second terminal “P3” is connected to the ground on the primary side through the second power wiring W2 and a second switching element M2. On the other hand, in the lower side transformer TL (second transformer), the first terminal “P1” is connected to the ground on the primary side through the second power wiring W2 and the second switching element M2, and the second terminal “P3” is connected to the ground on the primary side through the first power wiring W1 and the first switching element M1, on the opposite side of the upper side transformer TH (first transformer).

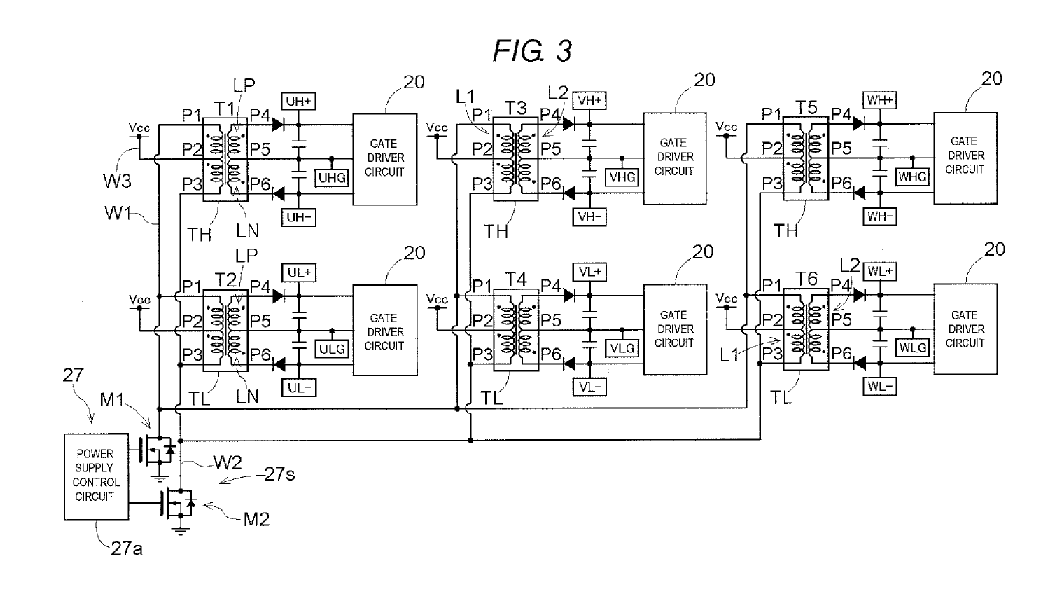

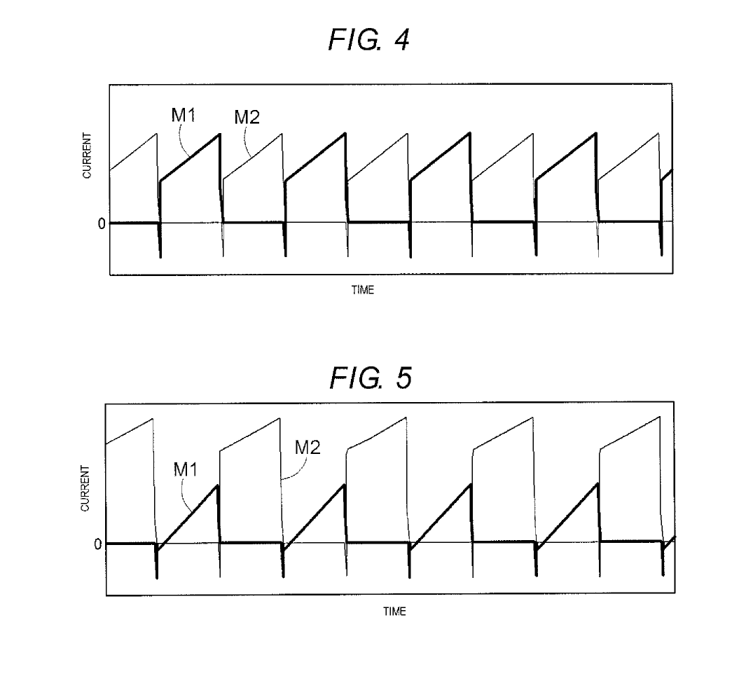

FIG. 3 illustrates a comparative example to FIG. 2. In the comparative example, each destination of the first power wiring W1 and the second power wiring W2, which are two wirings connecting the power source circuit 27 (AC power source) to each primary coil L1, is any one of two connection ends (P1, P3) of the primary coil L1, and identical with each other between the upper side transformer TH (first transformer) and the lower side transformer TL (second transformer). FIGS. 4 and 5 illustrate simulation results of a current waveform on the primary side. FIG. 4 illustrates a current waveform in the configuration example of FIG. 2, and FIG. 5 illustrates a current waveform in the configuration example (comparative example to FIG. 2) of FIG. 3. It is found that, in the current waveform of FIG. 4, no imbalance occurs in the power consumption of the switching elements (M1, M2), and in the current waveform of FIG. 5, an imbalance occurs in the power consumption of the switching elements (M1, M2).

In the circuit illustrated in FIG. 2, when the second switching element M2 turns on, a current of “P2 to P3” flows in a 2-3 winding of the primary coil L1 of each upper side transformer TH (first transformer), and a voltage corresponding to a winding ratio is generated in a 4-5 winding (positive output coil LP) of the secondary coil L2. Then, a current of “P4 to P5” flows through a diode and a capacitor, and a power is output to the gate driver circuits 20 from the positive output coil LP. Similarly, a voltage corresponding to a winding ratio is generated in a 5-6 winding (negative output coil LN) of the secondary coil L2. However, since a voltage at the terminal “P6” is higher than the voltage at the terminal “P5”, no current flows due to a diode connected reversely. Therefore, no power is output to the gate driver circuits 20 from the negative output coil LN.

In this situation, in each lower side transformer TL (second transformer), a current of “P2 to P1” flows in a 1-2 winding of the primary coil L1, and a voltage corresponding to a winding ratio is generated in a 5-6 winding (negative output coil LN) of the secondary coil L2. In this situation, the voltage at a terminal “P5” is higher than the voltage at a terminal “P6”, and a current of “P5 to P6” flows through the diode and the capacitor. As a result, a power is output to the gate driver circuits 20 from the negative output coil LN. Similarly, a voltage corresponding to a winding ratio is generated in a 4-5 winding (positive output coil LP) of the secondary coil L2. However, since a voltage at the terminal “P5” is higher than the voltage at the terminal “P4”, no current flows due to a diode connected reversely. Therefore, no power is output to the gate driver circuits 20 from the positive output coil LP.

On the other hand, in the circuit illustrated in FIG. 2, when the first switching element M1 turns on, a current of “P2 to P1” flows in a 1-2 winding of the primary coil L1 of each upper side transformer TH (first transformer), and a voltage corresponding to a winding ratio is generated in a 5-6 winding (negative output coil LN) of the secondary coil L2. In this situation, since the voltage at the terminal “P5” is higher than the voltage at the terminal “P6”, the current of “P5 to P6” flows through the diode and the capacitor. As a result, a power is output to the gate driver circuits 20 from the negative output coil LN. Similarly, a voltage corresponding to a winding ratio is generated in a 4-5 winding (positive output coil LP) of the secondary coil L2.

However, since a voltage at the terminal “P5” is higher than the voltage at the terminal “P4”, no current flows due to a diode connected reversely. Therefore, no power is output to the gate driver circuits 20 from the positive output coil LP.

In this situation, in each lower side transformer TL (second transformer), a current of “P2 to P3” flows in a 2-3 winding of the primary coil L1, and a voltage corresponding to a winding ratio is generated in a 4-5 winding (positive output coil LP) of the secondary coil L2. Then, a current of “P4 to P5” flows through a diode and a capacitor, and a power is output to the gate driver circuits 20 from the positive output coil LP. Similarly, a voltage corresponding to a winding ratio is generated in a 5-6 winding (negative output coil LN) of the secondary coil L2. However, since a voltage at the terminal “P6” is higher than the voltage at the terminal “P5”, no current flows due to a diode connected reversely. Therefore, no power is output to the gate driver circuits 20 from the negative output coil LN.

As described above, each upper side transformer TH (first transformer) and each lower side transformer TL (second transformer) complementarily output the power from the positive output coil LP and the negative output coil LN according to the first switching element M1 and the second switching element M2 whose on/off operation is complementarily controlled. Therefore, even when a difference occurs in the output power between the positive output coil LP and the negative output coil LN, a current flows in the first power wiring W1 and the second power wiring W2 in a balanced manner on the primary side of a pair of transformers (a pair of T1 and T2, a pair of T3 and T4, a pair of T5 and T6) that supplies the power to the gate driver circuits 20 corresponding to the upper and lower switching elements 10 configuring an arm of each phase (U-phase, V-phase, W-phase) of the inverter circuit 1 (refer to FIG. 4).

Hereinafter, the operation of the circuit in the comparative example illustrated in FIG. 3 will be described. Since the connection configuration of each upper side transformer TH (first transformer) to the first power wiring W1 and the second power wiring W2 is identical with the circuit of the first configuration example illustrated in FIG. 2, when the second switching element M2 turns on, the power is output to the gate driver circuit 20 from the positive output coil LP as with the circuit of the first configuration example. No power is output to the gate driver circuit 20 from the negative output coil LN. On the other hand, in the connection configuration of each lower side transformer TL (second transformer) to the first power wiring W1 and the second power wiring W2, the circuit of the first configuration example illustrated in FIG. 2 is different from the circuit of the comparative example illustrated in FIG. 3. In the comparative example, the upper side transformer TH (first transformer) and the lower side transformer TL (second transformer) are identical in the connection configuration with each other.

For that reason, even in the lower side transformer TL (second transformer), a power is output to the gate driver circuits 20 from the positive output coil LP. In other words, the current of “P2 to P3” flows in the 2-3 winding of the primary coil L1, and the voltage corresponding to the winding ratio is generated in the 4-5 winding (positive output coil LP) of the secondary coil L2. Then, the current of “P4 to P5” flows through the diode and the capacitor, and the power is output from the positive output coil LP. Similarly, a voltage corresponding to a winding ratio is generated in a 5-6 winding (negative output coil LN) of the secondary coil L2. However, since a voltage at the terminal “P6” is higher than the voltage at the terminal “P5”, no current flows due to a diode connected reversely. Therefore, no power is output to the gate driver circuits 20 from the negative output coil LN.

When the first switching element M1 turns on, the power is output from the negative output coil LN to the gate driver circuit 20 in each upper side transformer TH (first transformer), as with the circuit of the first configuration example. No power is output from the positive output coil LP to the gate driver circuit 20. In the circuit of the comparative example illustrated in FIG. 3, when the first switching element M1 turns on, the power is output from the negative output coil LN to the gate driver circuits 20 even in each lower side transformer TL (second transformer). In other words, in each lower side transformer TL (second transformer), the current of “P2 to P1” flows in the 1-2 winding of the primary coil L1, and the voltage corresponding to the winding ratio is generated in the 5-6 winding (negative output coil LN) of the secondary coil L2. Since the voltage at the terminal “P5” is higher than the voltage at the terminal “P6”, the current of “P5 to P6” flows through the diode and the capacitor, and the power is output from the negative output coil LN. Similarly, a voltage corresponding to a winding ratio is generated in a 4-5 winding (positive output coil LP) of the secondary coil L2. However, since a voltage at the terminal “P5” is higher than the voltage at the terminal “P4”, no current flows due to a diode connected reversely. Therefore, no power is output to the gate driver circuits 20 from the positive output coil LP.

In other words, in the circuit configuration of FIG. 3, each upper side transformer TH (first transformer) and each lower side transformer TL (second transformer) output the power from the respective coils of the same polarity according to the first switching element M1 and the second switching element M2 whose on/off operation is complementarily controlled. Therefore, when a difference occurs in the output power between the positive output coil LP and the negative output coil LN, currents flowing in the first power wiring W1 and the second power wiring W2 are unbalanced as illustrated in FIG. 5, on the primary side of a pair of transformers (a pair of T1 and T2, a pair of T3 and T4, a pair of T5 and T6) that supplies the power to the gate driver circuits 20 corresponding to the upper and lower switching elements 10 configuring an arm of each phase (U-phase, V-phase, W-phase) of the inverter circuit 1. As described above, the power is output from the negative output coil LN relatively small in the output power during a period in which the first switching element M1 is on. Therefore, as illustrated in FIG. 5, as compared with a period in which the first switching element M1 is on, a larger amount of current flows during a period in which the second switching element M2 is on, and an imbalance occurs in the power consumption on the primary side.

The description is made above with reference to FIG. 2. The configuration of the power supply circuit 2 (power conversion device) is not limited to the configuration (first configuration example) illustrated in FIG. 2. In the first configuration example, each two transformers (T1 and T2, T3 and T4, T5 and T6) corresponding to the positive and negative outputs are paired, and the paired two transformers are arranged to be different in the power wiring on the primary side from each other. In a second configuration example illustrated in FIG. 6, each two secondary coils L2 corresponding to positive and negative outputs are paired, and the paired two secondary coils L2 are configured so that the polarity of a positive output coil LP and the polarity of a negative output coil LN are different from each other.

As illustrated in FIG. 6, in the second configuration example, one transformer (T10, T30, T50) is provided in correspondence with an arm of each phase (U-phase, V-phase, W-phase) of an inverter circuit 1. Each of the transformers (T10, T30, T50) includes an upper side transformer TH (first transformer) that supplies the power to a gate driver circuit 20 of a switching element 10 on an upper (H) side of each phase of the inverter circuit 1, and the lower side transformer TL (second transformer) that supplies the power to the gate driver circuit 20 of the switching element 10 on a lower (L) side of each phase. In more detail, each transformer (T10, T30, T50) is configured as a composite transformer having different secondary coils L2 (4-5-6 winding and 7-8-9 winding) with respect to the common primary coil L1 (1-2-3 winding). In other words, the upper side transformer TH (first transformer) is configured by the 1-2-3 winding and the 4-5-6 winding, and the lower side transformer TL (second transformer) is configured by the 1-2-3 winding and the 7-8-9 winding.

In the second configuration example, in the primary coil L1 (1-2-3 winding), as in the first configuration example, an intermediate point “P2” is connected to a primary voltage (Vcc) through a third power wiring W3, and both ends “P1, P3” are connected to a ground (reference voltage “**G”) on the primary side through switching elements (M1, M2) which are supplementally switched through a power supply control circuit 27a, respectively. In the second configuration example, since a primary coil L is shared, in both of each upper side transformer TH (first transformer) and each lower side transformer TL (second transformer), the first terminal “P1” of the primary coil L1 is connected to the ground on the primary side through the first power wiring W1 and the first switching element M1, and the second terminal “P3” is connected to the ground on the primary side through the second power wiring W2 and the second switching element M2.

On the other hand, in the first configuration example, in both of each upper side transformer TH (first transformer) and each lower side transformer TL (second transformer), the configuration (polarity) of the secondary coils L2 is the same. On the other hand, in the second configuration example, in the transformer (T10, T30, T50) corresponding to the arm of each phase, the upper side transformer TH and the lower side transformer TL are configured so that the polarities of the positive output coil LP and the negative output coil LN are different from each other. In more detail, in the upper side transformer TH, both ends (terminal “P4” and terminal “P6”) of the 4-5-6 winding serving as the secondary coil L2 are positive poles. On the other hand, in the lower side transformer TL, an intermediate terminal “P8” of the 7-8-9 winding serving as the secondary coil L2 is a positive pole, and both ends (terminal “P7” and terminal “P9”) are negative poles. In the positive output coil LP (4-5 winding) of each upper side transformer TH (first transformer), the terminal “P4” is the positive pole. On the other hand, in the positive output coil LP (7-8 winding) of each lower side transformer TL (second transformer), the terminal “P8” is the positive pole. In the negative output coil LN (5-6 winding) of each upper side transformer TH (first transformer), the terminal “P6” is the positive pole. On the other hand, in the negative output coil LN (8-9 winding) of each lower side transformer TL (second transformer), the terminal “P8” is the positive pole.

In the circuit illustrated in FIG. 6, when the second switching element M2 turns on, a current of “P2 to P3” flows in a 2-3 winding of the primary coil L1 of each upper side transformer TH (first transformer), and a voltage corresponding to a winding ratio is generated in a 4-5 winding (positive output coil LP) of the secondary coil L2. Then, a current of “P4 to P5” flows through a diode and a capacitor, and a power is output to the gate driver circuits 20 from the positive output coil LP. Similarly, a voltage corresponding to a winding ratio is generated in a 5-6 winding (negative output coil LN) of the secondary coil L2. However, since a voltage at the terminal “P6” is higher than the voltage at the terminal “P5”, no current flows due to a diode connected reversely. Therefore, no power is output to the gate driver circuits 20 from the negative output coil LN.

In this situation, in each lower side transformer TL (second transformer), a current of “P2 to P3” flows in the 2-3 winding of the primary coil L1, whereby a voltage corresponding to a winding ratio is generated in the 8-9 winding (negative output coil LN) and the 7-8 winding (positive output coil LP) of the secondary coil L2. In this situation, since the voltage at the terminal “P8” is higher than the voltage at the terminal “P9”, the current of “P8 to P9” flows through the diode and the capacitor, and the power is output from the negative output coil LN to the gate driver circuit 20. On the other hand, since the voltage at the terminal “P8” is higher than the voltage at the terminal “P7”, no current of “P7 to P8” flows due to the diode connected reversely. Therefore, no power is output to the gate driver circuits 20 from the positive output coil LP.

When the first switching element M1 turns on, the current of “P2 to P1” flows in the 1-2 winding of the primary coil L1 of each upper side transformer TH (first transformer), and the voltage corresponding to the winding ratio is generated in the 5-6 winding (negative output coil LN) and the 4-5 winding (positive output coil LP) of the secondary coil L2. In this situation, since the voltage at the terminal “P5” is higher than the voltage at the terminal “P6”, the current of “P5 to P6” flows through the diode and the capacitor, and the power is output from the negative output coil LN to the gate driver circuit 20. On the other hand, since the voltage at the terminal “P5” is higher than the voltage at the terminal “P4”, no current of “P4 to P5” flows due to the diode connected reversely. Therefore, no power is output to the gate driver circuits 20 from the positive output coil LP.

In this situation, in each lower side transformer TL (second transformer), the current of “P2 to P1” flows in the 2-3 winding of the primary coil L1, whereby the voltage corresponding to a winding ratio is generated in the 7-8 winding (positive output coil LP) and the 8-9 winding (negative output coil LN) of the secondary coil L2. On the side of the positive output coil LP, a current of “P7 to P8” flows through the diode and the capacitor, and the power is output to the gate driver circuits 20. On the other hand, since the voltage at the terminal “P9” is higher than the voltage at the terminal “P8”, no current of “P8 to P9” flows due to the diode connected reversely, and no power is output to the gate driver circuit 20 from the negative output coil LN.

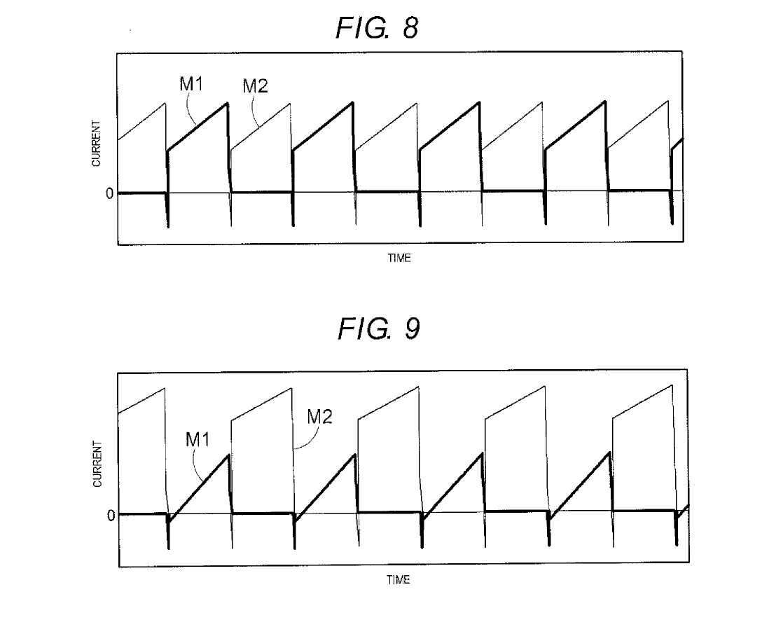

As described above, each upper side transformer TH (first transformer) and each lower side transformer TL (second transformer) complementarily output the power from the positive output coil LP and the negative output coil LN according to the first switching element M1 and the second switching element M2 whose on/off operation is complementarily controlled. Therefore, even when a difference occurs in the output power between the positive output coil LP and the negative output coil LN, the current flows in the first power wiring W1 and the second power wiring W2 in a balanced manner on the primary side of the transformers (T10, T30, T50) that supply the power to the gate driver circuits 20 corresponding to the upper and lower switching elements 10 configuring the arm of each phase (U-phase, V-phase, W-phase) of the inverter circuit 1 (refer to FIG. 8).

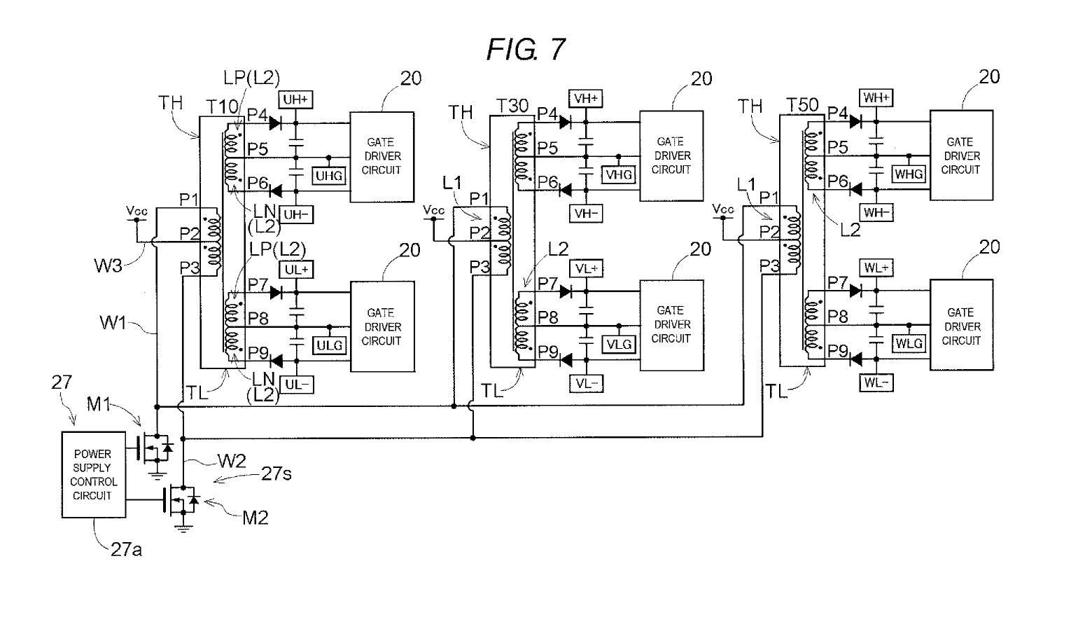

FIG. 7 illustrates a comparative example (second comparative example) to the second configuration example illustrated in FIG. 6. As in the second configuration example, in the comparative example, the common primary coil L1 is provided, and a pair of secondary coils L2 corresponding to the positive and negative outputs is provided. However, unlike the second configuration example, the polarities of the paired secondary coils L2 are the same. The operation of the second comparative example illustrated in FIG. 7 is identical with that of the comparative example (first comparative example) of the first configuration example described with reference to FIG. 4. Therefore, a detailed description will be omitted because the description can be easily conceivable from the above description.

FIG. 9 illustrates a current waveform on a primary side in the second comparative example. In the second configuration example, as illustrated in FIG. 8, a current on a primary side flows in a first power wiring W1 (first switching element M1) and a second power wiring W2 (second switching element M2) with a balance.

On the contrary, in a comparative example to the second configuration example, as illustrated in FIG. 9, currents flowing in a first power wiring W1 and a second power wiring W2 are unbalanced. As described above, the power is output from the negative output coil LN relatively small in the output power during a period in which the first switching element M1 is on. Therefore, as illustrated in FIG. 9, as compared with a period in which the first switching element M1 is on, a larger amount of current flows during a period in which the second switching element M2 is on, and an imbalance occurs in the power consumption on the primary side.

Meanwhile, FIG. 6 illustrates an example in which each transformer (T10, T30, T50) is configured as a composite transformer having multiple sets of secondary coils L2 (4-5-6 winding and 7-8-9 winding) with respect to the common primary coil L1. However, as in the first configuration example illustrated in FIG. 2, each transformer having the independent primary coil L1 and one set of secondary coils L2 corresponding to positive and negative outputs is provided as the upper side transformer TH (first transformer) and the lower side transformer TL (second transformer), and does not prevent the same circuit from being configured. However, in this configuration, the upper side transformer TH (first transformer) and the lower side transformer TL (second transformer) are configured by transformers different in configuration as hardware. In other words, two types of transformers are required as the power supply circuit 2 (power conversion device) (in the first configuration example, since only the wirings are different from each other, one type of transformer is configured). On the contrary, in the case of the composite transformer as in the second configuration example, the power supply circuit 2 can be configured by one type of transformer (composite transformer). As a result, the effects of a reduction in the costs attributable to mass production of the components, and a reduction in production costs by employing the same components are obtained.

In the power supply circuit 2 that supplies a power to the gate driver circuits 20 for driving the three-phase alternating current inverter circuit 1 generically used, it is preferable that the first configuration example and the second configuration example are selectively used according to a total number of transformers used in the power supply circuit 2. Since the first configuration example is suitable for a case in which the upper side transformers TH (first transformers) are independent from the lower side transformers TL (second transformers), it is preferable that the total number of transformers is even. On the other hand, it is preferable that the second configuration example is configured by the composite transformer in which the upper side transformer TH (first transformer) and the lower side transformer TL (second transformer) share the primary coil L1 with each other. Therefore, it is preferable that the total number of transformers (composite transformers) is odd.

In other words, when the total number of transformers (T1 to T6) is even, and the number of transformers (for example, T1, T3, T5) configuring a first group (for example, the upper side transformers TH) is identical with the number of transformers (for example, T2, T4, T6) configuring a second group (for example, the lower side transformers TL), the first configuration example (FIG. 2) is preferable. In other words, it is preferable that each destination of the first power wiring W1 and the second power wiring W2 is any one of two connection ends (for example, “P1” and “P3”) of the primary coil L1 (1-2-3 winding), and is different from each other between the transformers configuring the first group and the transformers configuring the second group.

In addition, when the total number of composite transformers (for example, T10, T30, T50) is odd, it is preferable that the polarities of the positive output coil LP and the negative output coil LN are different from each other in each of the upper side transformer TH (first transformer) and the lower side transformer TL (second transformer) of the composite transformer as in the second configuration example (FIG. 6). In the present specification, the composite transformer means that the number of outputs (the number on the secondary side) from one transformer is more than one, in other words, the number of outputs (the number on the secondary side) is more than one with respect to the input number “1” (the primary side). For example, as illustrated in FIG. 6, each composite transformer (T10, T30, T50) includes two sets (two pairs) of 4-5-6 winding and 7-8-9 winding as the secondary coils L2 each having a pair of the positive output coil LP and the negative output coil LN, and a common primary coil L1 (1-2-3 winding). The upper side transformer TH (first transformer) is formed by pairing the primary coil L1 with one set (pair) of secondary coils L2 (for example, 4-5-6 winding), and the lower side transformer TL (second transformer) is formed by pairing the primary coil L1 with the other set (pair) of secondary coils L2 (for example, 7-8-9 winding) to configure the composite transformer (T10, T30, T50).

In the first configuration example illustrated in FIG. 2, six transformers whose number of outputs is each “1” are used. Alternatively, two transformers (composite transformers) whose number of outputs is each “3” can be used to realize a modification of the first configuration example. In other words, one of the transformers is associated with the upper side transformers TH (first transformers) of the U-, V-, and W-phases, and the other transformers are associated with the lower side transformers TL (second transformers) of the U-, V-, and W-phases to realize the modification of the first configuration example. One transformer (composite transformer) is configured for each of the first group and the second group described above. In this situation, the total number of transformers is even, that is, “2”, and the destinations of the first power wiring W1 and the second power wiring W2 are made different between those two transformers (composite transformers) to reduce imbalance of the current on the primary side.

In the second configuration example illustrated in FIG. 6, three transformers (composite transformers) whose number of outputs is each “2” are used. Alternatively, one transformer (composite transformer) whose number of outputs is “6” can be used to realize a modification of the second configuration example. In the above configuration, one transformer (one composite transformer) includes six sets of secondary coils L2 each having the positive output coil LP and the negative output coil LN, and the common primary coil L1. The primary coil L1 is paired with the respective three secondary coils L2 to configure three upper side transformers TH (first transformers), and the primary coil is paired with the respective remaining three secondary coils L2 to configure three lower side transformers TL (second transformers). The polarities of the positive output coil LP and the negative output coil LN are different from each other between the upper side transformers TH (first transformers) and the lower side transformers TL (second transformers), to thereby realize the modification of the second configuration example. In this situation, the total number of transformers is odd, that is, “1”, and the polarities of the positive output coil LP and the negative output coil LN are made different from each other to reduce the imbalance of the current on the primary side.

As described above, the current on the primary side is balanced to allow the current flowing in the first switching element M and the second switching element M2 to become substantially equal to each other. As illustrated in FIGS. 3, 5, 7, 9, and so on, when the current flowing in the first switching element M1 is greatly different from the current flowing in the second switching element M2, there is a need to use the switching elements different in the electric characteristic according to the respective current consumptions. This leads to the possibility of increasing the component procurement costs caused by a reduction in the use quantity of single article, and increasing the component management costs associated with an increase in the types of components. Alternatively, when all of the switching elements are unified in a larger current capacity, there is a possibility that the component procurement costs are increased due to an excessive specification. However, when the current flowing in the first switching element M1 is substantially identical with the current flowing in the second switching element M2, the power source circuit 27 (AC power source) on the primary side can be configured by using the elements having the same electric characteristic. Therefore, when the imbalance of the current on the primary side is eliminated as described above, the power source circuit 27 (AC power source) on the primary side includes the switching control circuit 27s for switching the power supply to the primary coil L1 under control, and the switching control circuit 27s includes an even number of switching elements (M1, M2) having the same electric characteristic.

As has been described above, according to the disclosure, it is possible to realize a transformer type power conversion device configured to include a secondary coil having a positive output coil whose output voltage is positive with respect to a reference voltage of a secondary side and a negative output coil whose output voltage is negative, and to balance a power consumption of a circuit connected to a primary coil even when output powers of the positive output coil and the negative output coil are different from each other.

### Other Embodiments

Hereinafter, other embodiments of the disclosure will be described.

Incidentally, the configurations of respective embodiments described below are not limited to those respectively applied alone, but as long as no conflict arises, can be applied in combination with the configuration of other embodiments.

(1) In the above description, when the total number of transformers is even, the first configuration example is applied. However, when the total number of transformers (including the composite transformers) is odd, the first configuration example (its modification) is not prevented from being applied. In other words, even if the total number of transformers (including the composite transformers) is odd, each destination of the first power wiring W1 and the second power wiring W2 is not prevented from being any one of two connection ends of the primary coil L1, and being different from each other between the first transformer and the second transformer.

For example, when the transformers are not the composite transformers illustrated in FIG. 6, the respective transformers configure the first transformer and the second transformer. When the total number of transformers is odd, there is a possibility that the number of first transformers is not identical with the number of second transformers. Even in this case, each destination of the first power wiring W1 and the second power wiring W2 is any one of two connection ends of the primary coil L1, and different from each other between the first transformer and the second transformer, to thereby reduce the imbalance of the current on the primary side. It is needless to say that the same is applied to a case in which the total number of transformers is even, and the number of first transformers is not identical with the number of second transformers.

As in the second comparative example illustrated in FIG. 7, it is preferable that in each of the odd number of composite transformers, when the polarities of the positive output coil LP and the negative output coil LN are not different from each other between the first transformer and the second transformer, the connection configuration of the power wirings (W1, W2) is made different from each other. For example, in the composite transformers (T10, T50) corresponding to the arms of U-phase and W-phase, each destination of the first power wiring W1 and the second power wiring W2 is any one of the two connection ends of the primary coil L1, and made different from each other between the first transformer and the second transformer. In the composite transformer (T30) corresponding to the arm of V-phase, the first transformer is made identical with the second transformer. Even with this configuration, since the imbalance of the current on the primary side is reduced, the first configuration example (its modification) is not prevented from being applied in the case where the total number of transformers (including the composite transformers) is odd.

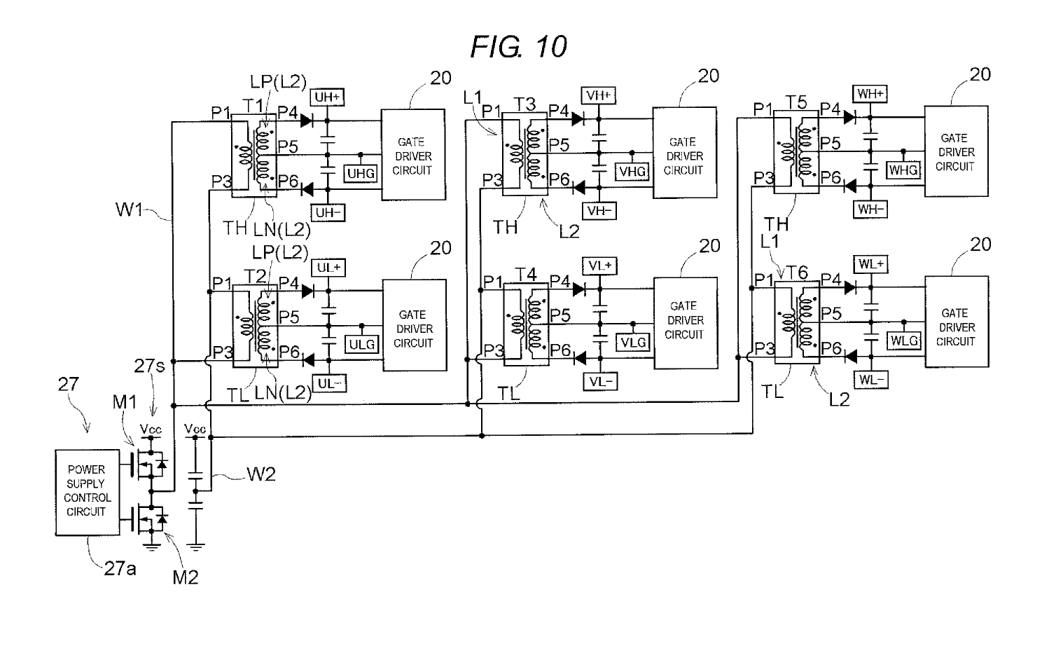

(2) In the above description, the push-pull type circuit configuration (refer to FIGS. 2 and 6) is illustrated as the power source circuit 27 (AC power source) on the primary side in the power supply circuit 2 (power conversion device). However, the configuration of the power source circuit 27 (AC power source) on the primary side is not limited to the push-pull type, but may be configured by, for example, a half-bridge type circuit as illustrated in FIG. 10. In addition, although not shown, the configuration of the power source circuit 27 (AC power source) on the primary side may be a full-bridge type circuit configuration. The half-bridge type and the full-bridge type circuit configurations are well known, the push-pull type circuit configuration would be easily conceivable from the above description by a person skilled in the art, and its detailed description will be omitted.

### Outline of Embodiments of the Disclosure

The outline of the power conversion device according to the embodiments of the disclosure as described above will be described in brief.

A characteristic configuration of a power conversion device according to the embodiments of the disclosure includes at least two transformers having a first transformer (TH) and a second transformer (TL), each for transforming a power between a primary coil (L1) and a secondary coil (L2), in which each secondary coil (L2) of the first transformer (TH) and the second transformer (TL) includes a positive output coil (LP) whose output voltage is positive, and a negative output coil (LN) whose output voltage is negative with respect to a reference voltage on a secondary side, and output powers of the positive output coil (LP) and the negative output coil (LN) are different from each other, each destination of a first power wiring (W1) and a second power wiring (W2) which are two wirings for connecting an AC power source (27) to the primary coils (L1) is any one of two connection ends of the primary coil (L1), and different from each other between the first transformer (TH) and the second transformer (TL), or polarities of the positive output coil (LP) and the negative output coil (LN) are different from each other between the first transformer (TH) and the second transformer (TL).

When each destination of the first power wiring (W1) and the second power wiring (W2) is any one of two connection ends of the primary coil (L1), and different from each other between the first transformer (TH) and the second transformer (TL), even if the first transformer (TH) and the second transformer (TL) are configured by the same hardware, actions on the secondary coils (L2) can be made different from each other. When the polarities of the positive output coil (LP) and the negative output coil (LN) are different from each other between the first transformer (TH) and the second transformer (TL), even if connection configurations of the power wirings to the first transformer (TH) and the second transformer (TL) are identical with each other, the actions on the secondary coils (L2) can be made different from each other. For example, a current flowing in the first power wiring (W1) acts on the negative output coil (LN) of the second transformer (TL) when acting on the positive output coil (LP) of the first transformer (TH), and acts on the positive output coil (LP) of the second transformer (TL) when acting on the negative output coil (LN) of the first transformer (TH). On the other hand, a current flowing in the second power wiring (W2) acts on the positive output coil (LP) of the second transformer (TL) when acting on the negative output coil (LN) of the first transformer (TH), and acts on the negative output coil (LN) of the second transformer (TL) when acting on the positive output coil (LP) of the first transformer (TH). In other words, since the currents flowing in the first power wiring (W1) and the second power wiring (W2) evenly act on the positive and negative outputs of the first transformer (TH) and the second transformer (TL), respectively, the current flows in the first power wiring (W1) and the second power wiring (W2) in a balanced manner. Therefore, the transformer type power conversion device configured to balance the power consumption of the circuits connected to the respective primary coils can be realized even when the positive output coil (LP) and the negative output coil (LN) are different in output power from each other.

As one configuration, it is preferable that the power conversion device is configured so that a total number of the transformers (T1 to T6) is even, the number of transformers configuring a first group is identical with the number of transformers configuring a second group, and each destination of the first power wiring (W1) and the second power wiring (W2) is any one of two connection ends of the primary coil (L1), and different from each other between the transformers configuring the first group and the transformers configuring the second group. When the total number of the transformers (T1 to T6) is even, the transformers can be divided evenly into the transformers configuring the first group and the transformers configuring the second group. In addition, the current flowing in the first power wiring (W1) acts on the negative output coils (LN) of the transformers configuring the second group when acting on the positive output coils (LP) of the transformers configuring the first group, and acts on the positive output coils (LP) of the transformers configuring the second group when acting on the negative output coils (LN) of the transformers configuring the first group. On the other hand, the current flowing in the second power wiring (W2) acts on the positive output coils (LP) of the transformers configuring the second group when acting on the negative output coils (LN) of the transformers configuring the first group, and acts on the negative output coils (LN) of the transformers configuring the second group when acting on the positive output coils (LP) of the transformers configuring the first transformer. In other words, since the currents flowing in the first power wiring (W1) and the second power wiring (W2) evenly act on the positive and negative outputs of the transformers configuring the first group and transformers configuring the second group, respectively, the current flows in the first power wiring (W1) and the second power wiring (W2) in a balanced manner.

As one configuration, it is preferable that the power conversion device is configured so that at least two sets of the secondary coils (L2) each including a pair of the positive output coil (LP) and the negative output coil (LN) are provided and a common primary coil (L1) is provided, the first transformer (TH) includes one pair of at least one set of the secondary coils (L2) and the primary coil (L1), and the second transformer (TL) includes a pair of another set of the secondary coils (L2) and the primary coil (L1) to configure composite transformers (T10, T30, T50), and a total number of the composite transformers (T10, T30, T50) is odd, and in each of the composite transformers (T10, T30, T50), the polarities of the positive output coil (LP) and the negative output coil (LN) are different from each other between the first transformer (TH) and the second transformer (TL). Since each of the composite transformers (T10, T30, T50) includes the first transformer (TH) and the second transformer (TL), even if the total number of the composite transformers (T10, T30, T50) is odd, the first transformers (TH) and the second transformers (TL) can be provided, evenly. In addition, each of the composite transformers (T10, T30, T50) is configured so that the polarities of the positive output coil (LP) and the negative output coil (LN) are different from each other. For example, a current flowing in the first power wiring (W1) acts on the negative output coil (LN) of the second transformer (TL) when acting on the positive output coil (LP) of the first transformer (TH), and acts on the positive output coil (LP) of the second transformer (TL) when acting on the negative output coil (LN) of the first transformer (TH). In addition, a current flowing in the second power wiring (W2) acts on the positive output coil (LP) of the second transformer (TL) when acting on the negative output coil (LN) of the first transformer (TH), and acts on the negative output coil (LN) of the second transformer (TL) when acting on the positive output coil (LP) of the first transformer (TH). In other words, since the currents flowing in the first power wiring (W1) and the second power wiring (W2) evenly act on the positive and negative outputs of the first transformer (TH) and the second transformer (TL), respectively, the current flows in the first power wiring (W1) and the second power wiring (W2) in a balanced manner.

In general, the circuit of the push-pull system or the bridge system is configured on the primary side of the power conversion device using the transformers, and the multiple switching elements (M1, M2) are used for those circuits. As described above, the current on the primary side is balanced to similarly allow the current flowing in the respective switching elements (M1, M2) to become substantially equal to each other. When the currents flowing in the respective switching elements (M1, M2) are largely different from each other, there is a need to use elements different in the electric characteristics according to the respective current consumptions. However, when the currents flowing in the respective switching elements (M1, M2) are substantially identical with each other, the power source circuit (AC power source (27)) on the primary side can be configured by using the elements having the same electric characteristic. Therefore, as one configuration, it is preferable that when the imbalance of the current on the primary side is reduced, the AC power source (27) of the power conversion device includes the switching control circuit (27s) that controls the switching operation of power supply to the primary coils (L1), and the switching control circuit (27s) includes an even number of switching elements (M1, M2) having the same electric characteristic. The same electric characteristic means that the switching elements are manufactured on the basis of the same specification, and belongs to the same range even if a difference is caused by a manufacturing error.

### INDUSTRIAL APPLICABILITY

The disclosure can be used in a power conversion device having a transformer that transforms a power between a primary coil and a secondary coil.

1. A power conversion device comprising:
at least two transformers having a first transformer and a second transformer, each for transforming a power between a primary coil and a secondary coil, wherein
each secondary coil of the first transformer and the second transformer includes a positive output coil whose output voltage is positive, and a negative output coil whose output voltage is negative with respect to a reference voltage on a secondary side, and output powers of the positive output coil and the negative output coil are different from each other,
each destination of a first power wiring and a second power wiring which are two wirings for connecting an AC power source to the primary coils is any one of two connection ends of the primary coil, and different from each other between the first transformer and the second transformer, or
polarities of the positive output coil and the negative output coil are different from each other between the first transformer and the second transformer.

2. The power conversion device according to claim 1, wherein
a total number of the transformers is even, the number of transformers configuring a first group is identical with the number of transformers configuring a second group, and each destination of the first power wiring and the second power wiring is any one of two connection ends of the primary coil, and different from each other between the transformers configuring the first group and the transformers configuring the second group.

3. The power conversion device according to claim 1, wherein
at least two sets of the secondary coils each including a pair of the positive output coil and the negative output coil are provided and a common primary coil is provided, the first transformer includes one pair of at least one set of the secondary coils and the primary coil, and the second transformer includes a pair of another set of the secondary coils and the primary coil to configure composite transformers, and
a total number of the composite transformers is odd, and in each of the composite transformers, the polarities of the positive output coil and the negative output coil are different from each other between the first transformer and the second transformer.

4. The power conversion device according to claim 1, wherein
the AC power source includes a switching control circuit that controls switching operation of power supply to the primary coils, and
the switching control circuit includes an even number of switching elements having the same electric characteristic.
